(19) United States
(12) Patent Application Publication
(10) Pub. No.: US 2007/0077340 A1
(43) Pub. Date: Apr. 5, 2007

(54) METHOD FOR PRODUCING FROZEN ODEN

(76) Inventors: Fumio NODA, Ishikawa (JP); Minoru Noda, Ibaraki (JP); Shuji Yamamoto, Ishikawa (JP); Kiyoharu Miyamoto, Ishikawa (JP); Hideo Morita, Shiga (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/534,686

(22) Filed: Sep. 25, 2006

(30) Foreign Application Priority Data
Oct. 5, 2005 (JP) 2005-293051

(51) Int. Cl. A23L 1/16

(52) U.S. Cl. 426/557

(57) ABSTRACT

The purpose of the present invention is to provide a method for producing a frozen Oden, which has a good taste after heating, and which is not required to be constantly boiled, such as, at a convenience store, and can be subsequently heated quickly in response to an order to provide one having good taste. The means for solution of the present invention is a method for producing a frozen Oden, wherein at least one type of protein selected from the group consisting of animal proteins and vegetable proteins is used as a main raw material, and the method comprises the steps of: adding processed starch and saccharide to the main raw material to be kneaded; heating the obtained kneaded mixture to obtain a kneaded product; heating the kneaded product in an Oden soup; and subjecting the flavored kneaded product to a high-voltage electric-field brine-freezing treatment.

### BACKGROUND OF THE INVENTION

1. Field of the Invention

The present invention relates to a method for producing a flavored frozen Oden (Japanese hot pot).

2. Description of the Related Art

Currently, Oden has tremendous popularity, and is the best-selling food in the category of cooking done within a pan. It has become particularly popular since it began to become available at convenience stores (CVSs).

However, it has been pointed out that various problems remain in order to further expand the market of Oden as described below.

(1) Increase in the amount of disposal at CVSs due to being past the expiration date

It is said that the current amount of disposal of processed foods, due to being past the expiration date, in Japan reaches 20,000,000 tons per year.

(2) It is said that Oden produces its best taste after boiling it for about 2 hours. However, Oden from CVSs is only boiled for about 0-8 hours, and therefore, the taste of Oden varies and the timing to provide the best taste is missed.

(3) When Oden is boiled at a CVS, smell of Oden permeates the store.

(4) When cooking Oden at home, it is not easy to boil it for such a long time as 2 hours, and therefore, the timing to provide the best taste is missed.

(5) Oden for home cooking generally comprises an agent for improving keeping quality, an antiseptic agent and the like, or is packaged and heated in order to preserve it for a longer period of time. Therefore, it seems unhealthy, and the quality of such Oden is often significantly low. In another case, a flavored Oden is frozen and defrosted if required to eat it. In this method, the water contained in the Oden forms ice crystals, and therefore, there is a drawback that the texture of the Oden is deteriorated when defrosting.

### SUMMARY OF THE INVENTION

The present invention is aimed at solving the above-described problem. The purpose of the present invention is to provide a method for producing a frozen Oden, which has a good taste after heating, and which is not required to be constantly boiled. For example, specifically at a convenience store, the Oden can be heated quickly in response to an order to provide one having good taste.

Another purpose of the present invention is to provide a method for producing a frozen Oden having a texture, which is similar to that in a state before freezing, even after defrosting.

In a method for producing a frozen Oden of the present invention, at least one type of protein selected from the group consisting of animal proteins and vegetable proteins is used as the main raw material. The method comprises the steps of: adding processed starch and saccharide to the main raw material to be kneaded; heating the obtained kneaded mixture to obtain a kneaded product; heating the kneaded product in an Oden soup; and subjecting the flavored kneaded product to a high-voltage electric-field brine-freezing treatment, thereby accomplishing the above-described purpose.

In one embodiment of the present invention, the processed starch is at least one type of starch selected from the group consisting of esterified starch, etherified starch, crosslinked starch and oxidized starch.

In one embodiment of the present invention, the content of the processed starch is 2 to 10 wt % of the kneaded product.

In one embodiment of the present invention, the saccharide is at least one type of saccharide selected from the group consisting of sugar, trehalose, oligosaccharide, sugar alcohol, starch syrup and reduced starch syrup.

In one embodiment of the present invention, the content of the saccharide is 2 to 15 wt % of the kneaded product.

In one embodiment of the present invention, the kneaded product further contains a flavoring material.

In one embodiment of the present invention, the high-voltage electric-field brine-freezing treatment is a treatment in which freezing is carried out to pass through a temperature range of 0 to −5° C. within 15 minutes and reach a temperature range of −20 to −40° C.

In a method for producing an Oden of the present invention, at least one type of protein selected from the group consisting of animal proteins and vegetable proteins is used as the main raw material. The method comprises the steps of: adding processed starch and saccharide to the main raw material to be kneaded; heating the obtained kneaded mixture to obtain a kneaded product; heating the kneaded product in an Oden soup; subjecting the flavored kneaded product to a high-voltage electric-field brine-freezing treatment to obtain a frozen Oden; and defrosting the frozen Oden, thereby accomplishing the above-described purpose.

According to the present invention, Oden, that can be handled easily and has a good preservability, and which has a good taste after heating, can be provided. As a result, Oden can be cooked easily at home, and for example, at a convenience store, it is not required to be constantly boiled, and can be heated quickly in response to an order to provide Oden having a superior taste.

That is, a required amount of Oden can be immediately served if required, and there is no need to boil Oden for a long period of time. Further, decrease in the commercial cost of Oden due to boiling for a long period of time can be prevented. Moreover, the turbidity of the heated flavoring liquid (Oden soup) can be reduced.

Furthermore, since a kneaded product contains saccharides and proteins, which provide resistance to freezing, when the kneaded product is subjected to a high-voltage electric-field brine-freezing treatment, the temperature of the kneaded product, which is decreased during freezing, may pass through the maximum ice crystal generation range (0 to −5° C.) as fast as possible. Therefore, growth of ice crystals formed from water contained in the kneaded product is inhibited. Thus, preventing a structural breakdown, and the state of the kneaded product before freezing can be retained when defrosted.

Since a flavored Oden, that is boiled for the most suitable period of time using the suprior Oden soup, and then frozen utilizing the new freezing technique, is defrosted using a microwave oven just before eating, there is no need to add an antiseptic agent thereto, and Oden in the best state can be served. Further, at each CVS, permeating of smell and disposal of Oden can be prevented. Moreover, the present invention can also be applied to Oden which is sold at a vending machine.

### DESCRIPTION OF THE PREFERRED EMBODIMENTS

Hereinafter, embodiments of the present invention will be explained in detail.

In a method for producing a frozen Oden of the present invention, firstly, animal proteins and/or vegetable proteins are used as a main raw material, to which a given amount of a given processed starch and a given saccharide are added, and a flavoring material is added thereto if required. The resultant mixture is then kneaded and heated to obtain a kneaded product.

As animal proteins, paste or pieces of seafood such as walleye pollock, cod, Atka mackerel, white croaker, lizard fish, sardine, scallop and the like, the meat of farmed-animals such as pigs, cattle, birds, rabbits and the like, isolated proteins such as gelatin, collagen and the like can be suitably used. As vegetable proteins, soybean, wheat, isolated soybean protein or wheat-gluten can be suitably used. These raw materials can be used in any combination.

In the method for producing a frozen Oden of the present invention, processed starch and saccharide are used in combination in order to provide resistance to freezing and to improve the texture of the Oden.

Examples of processed starches include: esterified starch, which is obtained by esterifying a free hydroxyl group in glucose, which is the monosaccharide that constitutes starch; etherified starch, which is obtained by substituting a hydrogen atom in a hydroxyl group with an alkyl group; crosslinked starch, which is obtained by binding the hydroxyl groups in starch; and oxidized starch, which is obtained by oxidizing a reducing terminal of starch sugar with an oxidant.

Examples of suitable esterified starches to be used include Matsutani Yuri 8 and Food Starch NE1 manufactured by Matsutani Chemical Industry Co., Ltd., and Kemisuta 210 manufactured by Glico Foods Co., Ltd. Examples of suitable etherified starches to be used include Matsutani Yuri 2 manufactured by Matsutani Chemical Industry Co., Ltd. and Kemisuta 200 manufactured by Glico Foods Co., Ltd. Examples of suitable crosslinked starches to be used include Perfect Oamiru AC75 manufactured by Matsutani Chemical Industry Co., Ltd. and Kemisuta 420 manufactured by Glico Foods Co., Ltd. Examples of suitable oxidized starches to be used include Kemisuta 10T and Kemisuta 50H manufactured by Glico Foods Co., Ltd.

The above-described processed starches can be used solely or in any combination. The amount thereof to be used is preferably 2 to 10 wt % of the kneaded product, and more preferably 6 to 9 wt %. When the amount of the processed starch used is less than 2 wt %, denaturation due to freezing tends to occur easily, and when more than 10 wt %, the texture thereof is deteriorated.

The influence of the type and the amount of processed starch to be added on the quality of frozen Oden will be described below.

1.8 kg of salt was added to 60 kg of walleye pollock paste, and the mixture was mashed with a food cutter. After that, 5.7 kg of trehalose, 1.5 kg of sweet cooking rice wine and 27.9 kg of water were mixed therewith to prepare 96.9 kg of total mixture.

The resultant mixture was then divided into 17 portions (each portion: 5.7 kg). Naught to 12.5 wt % of etherified starch (Matsutani Yuri 8) was added to portions 1-7. Five or 10 wt % of non-treated potato starch was added to portions 8 and 9. Five or 10 wt % of esterified starch (Kemisuta 210) was added to portions 10 and 11. Five or 10 wt % of crosslinked starch (Perfect Amiru AC75) was added to portions 12 and 13. Five or 10 wt % of oxidized starch (Kemisuta 10H) was added to portions 14 and 15. Five or 10 wt % of a mixture containing 50% Matsutani Yuri 8 and 50% Kemisuta 210 was added to portions 16 and 17. After kneading, 100 g of each resultant mixture was put into a cup to be subsequently heated at 90° C. for 20 minutes.

Next, the obtained kneaded product was heated in an Oden soup.

As a flavoring liquid (Oden soup) to be used in this flavoring step, a soup similar to a general Oden soup, or a soup containing more flavoring materials than the general one (for example, 2 to 3-fold concentrated liquid) can be used. For example, salt, soy sauce, sweet cooking rice wine, sugar, Japanese sake and the like are suitably mixed with a dashi-jiru (soup).

In the flavoring step, conditions for heating a kneaded product in a flavoring liquid, and immersing the kneaded product under pressure or reduced pressure vary depending on the type of the kneaded product and the concentration of the flavoring liquid. Further, the temperature and the time of immersing vary depending on a state under pressure or reduced pressure. The kneaded product is immersed in the flavoring liquid using a pressure cooker to be under pressure or using a decompression cooker to be under reduced pressure, and the kneaded product is sufficiently flavored by the taste of the flavoring liquid under each condition.

Examples of the kneaded products include fish-kneaded products such as broiled foods, e.g., chikuwa (fish sausage) and the like, fried foods, e.g., burdock roll, squid roll and the like, and tsumire (a meat paste product), etc.

Next, after cooling at room temperature, each mixture was frozen using a high-voltage electric-field alcohol freezing machine for 20 minutes to obtain a frozen kneaded product at −25° C.

Each kneaded product obtained from each of the 17 portions was defrosted 1 week after, and subjected to a physical property test and a sensory test. The results are shown in Table 1.

TABLE 1

| | | Added | | |
|---|---|---|---|---|
| | | Amount | Physical | Sensory |
| Portion | Type of Starch | (%) | Properties | Test |
| 1 | Etherified Starch | 0 | Unacceptable | −0.9 |
| 2 | (Matsutani Yuri 8) | 1.0 | Unacceptable | −0.2 |
| 3 | | 2.0 | Good | +0.3 |
| 4 | | 5.0 | Excellent | +0.5 |
| 5 | | 7.5 | Excellent | +0.6 |
| 6 | | 10.0 | Excellent | +0.4 |
| 7 | | 12.5 | Unacceptable | −0.3 |
| 8 | Non-Treated Potato | 5.0 | Unacceptable | −0.9 |
| 9 | Starch | 10.0 | Unacceptable | −0.6 |
| 10 | Esterified Starch | 5.0 | Excellent | +0.6 |
| 11 | (Kemisuta 210) | 10.0 | Excellent | +0.5 |
| 12 | Crosslinked Starch | 5.0 | Excellent | +0.5 |
| 13 | (Perfect Amiru AC75) | 10.0 | Excellent | +0.4 |
| 14 | Oxidized Starch | 5.0 | Good | +0.3 |
| 15 | (Kemisuta 10H) | 10.0 | Good | +0.3 |
| 16 | Mixture (Matsutani | 5.0 | Excellent | +0.5 |
| 17 | Yuri 8 + Kemisuta | 10.0 | Excellent | +0.5 |
| | 210) | | | |

According to the results, portions 1 and 2 to which processed starch was not added in an amount of 2.0 to 10.0 wt % had denaturated due to freezing. Portion 7 had a deteriorated texture, and all of them were inferior to the non-frozen portion 1 in terms of both the physical property test and the sensory test.

Portions 8 and 9, to which potato starch, which is not a processed starch, was added, also showed inferior properties.

Non-frozen portion 1 was used as a reference for the assessment of physical properties. The assessment was carried out by a panel consisting of 10 persons, who made an evaluation as follows: Excellent: texture excels that of the reference; Good: texture is slightly better than that of the reference; Acceptable: texture is almost the same as that of the reference; and Unacceptable: texture is inferior to that of the reference. The results were derived from the most-received evaluation.

Non-frozen portion 1 was used as a reference for the sensory assessment. The judgment was carried out by a panel consisting of 10 persons, who made an evaluation as follows: +1: Excellent; 0: Similar; and −1: Inferior. The results were derived as the average points of the evaluation.

As saccharides for providing resistance to freezing, sugar, trehalose, oligosaccharide, sugar alcohol, starch syrup and reduced starch syrup can be suitably used. The amount thereof to be used is preferably 2 to 15 wt %, and particularly preferably 3 to 12 wt %. When the amount of the saccharides used is less than 2 wt % or more than 15 wt %, water tends to separate and thus the texture tends to degrade.

The influence of the type and the amount of saccharides added, on the quality of a kneaded product will be described below.

1.4 kg of salt was added to 52 kg of walleye pollock paste, and the mixture was mashed with a food cutter. After that, 6.0 kg of processed starch (trade name: Kemisuta 200), 0.6 kg of sweet cocking rice wine and 27.0 kg of water were mixed therewith to prepare 87.0 kg of mixture.

The resultant mixture was divided into 15 portions (each portion: 5.8 kg). Naught to 20 wt % of trehalose was added to portions 1-7. Five or 10 wt % of sugar was added to portions 8 and 9. Five or 10 wt % of oligosaccharide was added to portions 10 and 11. Five or 10 wt % of starch syrup was added to portions 12 and 13. Five or 10 wt % of reduced starch syrup was added to portions 14 and 15. After kneading, 100 g of each resultant mixture was put into a cup to be heated at 90° C. for 20 minutes.

After cooling at room temperature, each mixture was frozen using a high-voltage electric-field alcohol freezing machine for 20 minutes to obtain a frozen kneaded product at −25° C. Each kneaded product obtained from each of the 15 portions was defrosted, and subjected to a physical property test and a sensory test. The results are shown in Table 2.

TABLE 2

| | Type of | Added | Physical | Sensory |
|---|---|---|---|---|
| Portion | Saccharide | Amount | Properties | Test |
| 1 | Trehalose | 0 | Unacceptable | −0.9 |
| 2 | | 1.0 | Unacceptable | −0.2 |
| 3 | | 2.5 | Good | +0.3 |
| 4 | | 5.0 | Excellent | +0.8 |
| 5 | | 10.0 | Excellent | +0.5 |
| 6 | | 15.0 | Good | +0.3 |
| 7 | | 20.0 | Acceptable | −0.1 |
| 8 | Sugar | 5.0 | Excellent | +0.8 |
| 9 | | 10.0 | Excellent | +0.4 |
| 10 | Oligosaccharide | 5.0 | Excellent | +0.7 |
| 11 | | 10.0 | Excellent | +0.5 |
| 12 | Starch Syrup | 5.0 | Excellent | +0.7 |
| 13 | | 10.0 | Excellent | +0.4 |
| 14 | Reduced | 5.0 | Excellent | +0.6 |
| 15 | Starch Syrup | 10.0 | Excellent | +0.4 |

According to the results, a sample of portion 1, to which no saccharide was added, denaturated due to freezing, and in this case, the water separated and the sample did not have a soft texture at all. The sample also showed inferiority in the sensory test.

The results of portions 2-7, to which trehalose was added, were as follows. Regarding portion 2, no water separation was observed, but the sample had a watery texture and was inferior in the sensory test. Regarding portions 3-6, the samples provided excellent physical properties and had good results in the sensory test. Regarding portion 7, no water separation was observed, but the sample texture was paste-like, and was inferior in the sensory test.

In view of the results, it was judged that the suitable amount of saccharide to be added is 2 to 15 wt % of a kneaded product.

The samples of the portions 8-15, to each of which a saccharide other than trehalose was added in an amount of 5 to 10 wt %, had good results in both the physical property test and the sensory test.

Non-frozen portion 1 was used as a reference for assessing physical properties. The judgment was carried out by a panel consisting of 10 persons, who made an evaluation as follows: Excellent: texture excels that of the reference; Good: texture is slightly better than that of the reference; Acceptable: texture is almost the same as that of the reference; and Unacceptable: texture is inferior to that of the reference. The results were derived from the most-received evaluation.

Non-frozen portion 1 was used as a reference for the sensory assessment. The judgment was carried out by a panel consisting of 10 persons, who made an evaluation as follows: +1: Excellent; 0: Similar; and −1: Inferior. The results were derived as the average points of the evaluation.

Next, methods of freezing were evaluated.

0.5 kg of salt was added to 17 kg of walleye pollock paste, and the mixture was subsequently mashed with a food cutter. After that, 2 kg of trehalose, 1.5 kg of processed starch (trade name: Farinex), 0.2 kg of sweet cooking rice wine and 6.6 kg of water were mixed therewith to prepare 27.8 kg of mixture. The resultant mixture was divided into 5 portions (each portion: 5.56 kg). 100 g of each portion was put into a cup, which was then sealed, and then heated at 90° C. for 20 minutes.

Portion 1 was cooled in a refrigerator at 5° C. Portion 2 was frozen to −25° C., wherein duration of freezing in the range from 0 to −5° C. was regulated to be 20 minutes by controlling the temperature of a high-voltage electric-field alcohol freezing machine. Portion 3 was frozen to −25° C., wherein the duration of freezing in the range from 0 to −5° C. was regulated to be 15 minutes. Portion 4 was frozen to −25° C., wherein the duration of freezing in the range from 0 to −5° C. was regulated to be 10 minutes. Portion 5 was frozen to −25° C., wherein the duration of freezing in the range from 0 to −5° C. was regulated to be 15 minutes by controlling the temperature of a commercial large freezer. The portions were subsequently defrosted 24 hours later and subjected to the sensory test, using portion 1 as a reference.

The duration of freezing in the range from 0 to −5° C. was measured by a temperature sensor. In the sensory test, judgment was carried out by a panel consisting of 10 persons, who made evaluations as follows: 0: No difference from the reference; +1: Excellent compared to the reference; and −1: Inferior to the reference. The results were derived from the average points of the evaluation, as in Table 3.

TABLE 3

| | | Duration of Freezing | |
|---|---|---|---|
| | | in the Range from 0 | Sensory |
| Portion | Refrigerator | to −5° C. | Test |
| 1 | Cooling in | — | 0 |
| | Refrigerator at 5° C. | | |
| 2 | High-Voltage Electric- | 20 minutes | −0.2 |
| | Field Alcohol | | |
| | Freezing Machine | | |
| 3 | High-Voltage Electric- | 15 minutes | +0.4 |
| | Field Alcohol | | |
| | Freezing Machine | | |
| 4 | High-Voltage Electric- | 10 minutes | +0.6 |
| | Field Alcohol | | |
| | Freezing Machine | | |
| 5 | Large Freezer | 15 minutes | −0.3 |

It was found that high evaluation scores were obtained when the duration of freezing in the range from 0 to −5° C. was regulated to be 15 minutes or less (more preferably 10 minutes or less) using a high-voltage electric-field alcohol freezing machine. No desired effect was obtained using a large freezer, even when the duration of freezing, in the range from 0 to −5° C., was regulated to be 15 minutes.

In the present invention, “high-voltage electric-field brine” refers to a method for freezing a cooked food by providing a high-voltage electric-field to brine using a brine-freezing apparatus having an electrode inserted into brine, and a high-voltage electric-field generation means. The temperature of the brine is preferably in the range from −20 to −40° C., and the electric potential of the high-voltage electric-field generation means is preferably in the range from 5 to 50 kV. The outline of the freezing apparatus to be used is as follows.

One of two electrodes of the high-voltage electric-field generation means is inserted into brine of the brine-freezing apparatus. The other electrode is not inserted into the brine of the brine-freezing apparatus, but is subjected to an insulation treatment so as not to pass a current between the above-described two electrodes. These electrodes are connected to a secondary side of a high-frequency electric-potential generation apparatus, as shown in Japanese Publication for Opposition No. 38-6106.

The brine is then cooled using a freezing machine connected to the freezing apparatus, and circulated using a circulation apparatus with a drive motor in order to maintain a constant temperature in a tank containing the brine.

When installing the freezing apparatus, the high-voltage electric-field generation means and the drive motor of the circulation apparatus, glass insulation is used as a support between the floor surface and each apparatus.

An anti-freeze solution to be used for the brine is not particularly limited as long as it does not freeze at a target temperature. Examples thereof include, calcium chloride, ethylene glycol, propylene glycol, ethanol, and mixtures thereof, or mixtures thereof and water. For example, a mixture of water and ethanol may be used.

An apparatus for sealing food is used in order to subject the food to brine for freezing and to carry out freezing and cooking simultaneously by packaging a flavoring solution together with the food.

By freezing the kneaded product with a high-voltage electric-field, the temperature employed in the method for producing a frozen Oden, which is decreased during freezing, may pass through the maximum ice crystal generation range (0 to −5° C.) as fast as possible. Therefore, growth of ice crystals formed from water contained in the kneaded product is inhibited, thereby preventing structural breakdown, and the state of the food material before freezing can be retained when subsequently defrosted.

### EXAMPLES

Hereinafter, the present invention will be specifically described by way of illustrative examples.

### Example 1

0.3 kg of salt, 3 kg of processed starch (trade name: Kemisuta 200; manufactured by Glico Foods Co., Ltd.), 0.5 kg of sweet cooking rice wine, 3 kg of oligosaccharide (trade name: Nyuka Oligo; manufactured by Hayashibara Corporation) and 10 kg of water were mixed with 15 kg of chicken, and the mixture was kneaded using a silent cutter to obtain a kneaded product.

A tablespoon of salt, a ½ cup of sweet cooking rice wine and a ¼ cup of thin soy sauce were mixed with 10 cups (2 liter) of dashi-jiru (soup), which was made using kelp and dried bonito, to obtain a flavoring liquid.

The obtained kneaded product was then cooked within the flavoring liquid at 85° C. for 2 hours, and then put into a container and sealed.

After cooling, it was frozen with a high-voltage electric-field alcohol freezing machine (trade name: Quick Freezer Type RQF-50; manufactured by Alpha System Corporation), whose temperature was set at −40° C., for 20 minutes (duration of freezing in the range from 0 to −5° C.: 5 minutes), to produce frozen Oden at −35° C.

The frozen Oden was preserved at −35° C. for 3 or 6 months, and after that, subjected to microwave heating (500 W) for 30 seconds. When the heated flavored Oden was tasted, no denaturation due to freezing was recognized, and the Oden was flavored uniformly and sufficiently and had a good taste.

### Example 2

10 kg of separated soybean protein, 0.1 kg of soybean oil, 1.8 kg of processed starch (trade name: Perfect Amiru AC75; manufactured by Matsutani Chemical Industry Co., Ltd.), 1.5 kg of reduced starch syrup (trade name: Amamiru HS-60; manufactured by Hayashibara Corporation) and 4.5 kg of water were mixed together and kneaded by a kneader to obtain a kneaded product.

A tablespoon of salt, a ½ cup of sweet cooking rice wine and a ¼ cup of thin soy sauce were then mixed with 10 cups (2 liter) of dashi-jiru (soup), which was made using kelp and dried bonito, to obtain a flavoring liquid.

The obtained kneaded product was then cooked within the flavoring liquid at 85° C. for 2 hours, and then put into a container and it was sealed.

After cooling, it was frozen with a high-voltage electric-field alcohol freezing machine (trade name: Quick Freezer Type RQF-50; manufactured by Alpha System Corporation), whose temperature was set at −40° C., for 20 minutes (duration of freezing in the range from 0 to −5° C.: 4 minutes), to produce frozen Oden at −35° C.

The frozen Oden was preserved at −35° C. for 3 or 6 months, and after that, subjected to microwave heating (500 W) for 30 seconds. When the heated flavored Oden was tasted, no denaturation due to freezing was recognized, and the Oden was flavored uniformly and sufficiently and had a good taste.

### Example 3

12 kg of walleye pollock paste, 3 kg of gluten powder, 0.4 kg of salt, 3 kg of trehalose, 3 kg of processed starch (trade name: Kemisuta 300S; manufactured by Glico Foods Co., Ltd.), 0.6 kg of sweet cooking rice wine and 10 kg of water were mixed together and kneaded by a Stephan cutter. The kneaded product was divided into balls (each ball: 20 g), and they were boiled at 90° C. for 20 minutes.

10 balls of the kneaded product and 200 ml of Oden soup were put into a bag, which was then sealed, and after that, the bag was held at 85° C. for 2 hours.

After cooling, it was frozen by a high-voltage electric-field alcohol freezing machine (trade name: Quick Freezer Type RQF-50; manufactured by Alpha System Corporation) whose temperature was set at −45° C. for 20 minutes (duration of freezing in the range from 0 to −5° C.: 4 minutes), to produce a frozen Oden at −40° C.

The frozen Oden was preserved at −35° C. for 3 or 6 months, and after that, subjected to microwave heating (500 W) for 30 seconds. When the heated flavored Oden was tasted, no denaturation due to freezing was recognized, and the Oden was flavored uniformly and sufficiently and had a good taste.

What is claimed is:

1. A method for producing a frozen Oden, wherein at least one type of protein selected from the group consisting of animal proteins and vegetable proteins is used as a main raw material, the method comprising the steps of:
adding processed starch and saccharide to the main raw material to be kneaded;
heating the obtained kneaded mixture to obtain a kneaded product;
heating the kneaded product in an Oden soup; and
subjecting the flavored kneaded product to a high-voltage electric-field brine-freezing treatment.

2. The method for producing a frozen Oden according to claim 1, wherein the processed starch is at least one type of starch selected from the group consisting of esterified starch, etherified starch, crosslinked starch and oxidized starch.

3. The method for producing a frozen Oden according to claim 1, wherein the content of the processed starch is 2 to 10 wt % of the kneaded product.

4. The method for producing a frozen Oden according to claim 1, wherein the saccharide is at least one type of saccharide selected from the group consisting of sugar, trehalose, oligosaccharide, sugar alcohol, starch syrup and reduced starch syrup.

5. The method for producing a frozen Oden according to claim 1, wherein the content of the saccharide is 2 to 15 wt % of the kneaded product.

6. The method for producing a frozen Oden according to claim 1, wherein the kneaded product further contains a flavoring material.

7. The method for producing a frozen Oden according to claim 6, wherein the high-voltage electric-field brine-freezing treatment is a treatment in which freezing is carried out to pass through a temperature range of 0 to −5° C. within 15 minutes and reach a temperature range of −20 to −40° C.

8. A method for producing an Oden, wherein at least one type of protein selected from the group consisting of animal proteins and vegetable proteins is used as a main raw material, the method comprising the steps of:
adding processed starch and saccharide to the main raw material to be kneaded;
heating the obtained kneaded mixture to obtain a kneaded product;
heating the kneaded product in an Oden soup;
subjecting the flavored kneaded product to a high-voltage electric-field brine-freezing treatment to obtain a frozen Oden; and
defrosting the frozen Oden.
